(19) United States
(12) Patent Application Publication
(10) Pub. No.: US 2011/0318463 A1
(43) Pub. Date: Dec. 29, 2011

(54) System and Method for Pasteurizing Milk

(75) Inventors: Forrest MacGregor, Randolf, VT (US); Steven Judge, Royalton, VT (US)

(73) Assignee: BOB WHITE SYSTEMS, INC., South Royalton, VT (US)

(21) Appl. No.: 12/884,777

(22) Filed: Sep. 17, 2010

Related U.S. Application Data
(60) Provisional application No. 61/243,413, filed on Sep. 17, 2009.

(51) Int. Cl. A23C 3/033; B08B 3/10; B08B 9/00; A23C 3/02

(52) U.S. Cl. 426/522; 99/453; 134/166 R; 134/22.12

(57) ABSTRACT

Systems and methods are provided for pasteurizing milk or other fluids, and for cleaning and disinfecting processing passageways prior to and after the milk processing. The disclosed pasteurization systems and methods have very low impact on the characteristics of raw, unpasteurized milk (e.g., texture, flavor, and/or nutritional value). For example, some systems and methods utilize a pump that operates at a very low flow rate (e.g., about 1 gallon per minute (GPM)) to prevent mechanical adulteration of the raw milk. Disclosed systems and methods for cleaning and disinfecting the fluid passageways also utilize a low-flow rate, and can use the same low flow pump that is utilized during pasteurization. A pressure pulser allows pressure to build up within the fluid passageways despite the low flow, and then releases the pressure to purge air from the passageways and to cause their interior surfaces to contact the cleaning fluid.

### CROSS-REFERENCE TO RELATED APPLICATION

This application claims the benefit of U.S. Provisional Patent Application No. 61/243,413, filed Sep. 17, 2009, which is hereby incorporated by reference herein in its entirety.

### FIELD OF THE DISCLOSURE

Systems and methods are provided for pasteurizing milk or other fluids, and for cleaning and disinfecting processing passageways prior to and after the milk processing. Some embodiments of the systems and methods disclosed herein enable economic scaling of a pasteurization system, reductions in adulteration of the resulting milk product, and improvements in the manner in which the pasteurizing system can be cleaned and disinfected.

### BACKGROUND OF THE DISCLOSURE

It only takes four cows to supply as many as sixty families with fresh milk. Yet, most milk is trucked in sometimes over hundreds of miles from a small number of large suppliers. For example, thirty years ago in the United States, New England's dairy farms produced almost 100% of the milk consumed by New Englanders. Today those farms produce only 7% of the milk consumed in that region. Simply stated, smaller dairy farms have been unable to compete with the larger, factory-styled milk processing facilities, some of which milk tens of thousands of cows. Many of the larger facilities are located in milder climates (e.g., midwestern states) where labor, taxes, feed, and land are less expensive. In addition, larger facilities have traditionally been promoted as a means to maintain a plentiful supply of safe and inexpensive milk.

Even when milk originates from local, relatively smaller farms, the current practice for most milk processing includes collecting the milk, aggregating it, and transporting it to the larger continuous processing plants. These plants pasteurize the milk for safety reasons and typically homogenize it as well, before packaging and distributing it, for example, back to the locales from whence it originated. This process introduces significant delays, reduces the overall milk quality (e.g., by mixing the best in with the worst), and adds cost to the entire product/process chain. It also significantly alters the milk, including in terms of its texture and flavor. Suffice it to say that what may have originated as farm-fresh, high quality milk may be very different from the milk product that is ultimately consumed by the public.

The current practice in milk safety processing is to perform pasteurization on raw milk in order to reduce both pathogenic and lactogenic bacteria counts. There are literally millions of dairy animals in the United States, and prior to federal regulation of milk processing, it was not uncommon for the public to suffer disease outbreaks that included both serious sickness and death. Pasteurization uses heat treatments that have been empirically determined to be lethal to the most common and potentially lethal bacteria. The process has been used for more than 150 years, and it is positively correlated with increases in public health wherever it is implemented. Economies of scale and cost concerns have traditionally put the pasteurization process within the domain of larger-production facilities. Smaller dairy farms have lacked the systems necessary to quickly and inexpensively pasteurize raw milk on their own.

Several different time and temperature profiles have been developed for pasteurization processes, and they basically fall into three major categories:
1. Batch pasteurizing—e.g., low temp, long time, at (for example) 145° F., for 90 minutes;
2. Flash pasteurizing—e.g., high temp, short time, or “HTST”, at (for example) 161° F., for 15 seconds; and
3. Ultra-pasteurizing—e.g., very high temp and very short duration, at (for example) 230° F., for 1.5 seconds.

Pasteurizing standards vary slightly from country to country, and in the United States, the FDA Pasteurized Milk Ordinance (PMO) governs commercial milk sold across state lines. Within individual states, state agencies and regulations apply to the processing, labeling, and sale of milk products. State regulations are generally less stringent than Federal regulations, and in many states the sale of unprocessed raw milk is completely legal—in many cases with no inspection required. The PMO establishes Federal criteria for the processing, labeling, and recordkeeping of dairy products and allows generally unsophisticated consumers to identify milk that has been processed in accordance with these standards, with “Grade A” being the highest.

Pathogenic sources for milk include fecal contamination and active disease processes within individual dairy cows or other dairy animals. Most pathogens are relatively benign, but others have the potential to be lethal to healthy humans and especially lethal to individuals with compromised immune systems.

Fortunately, pasteurization can dramatically improve milk safety, but as with all industrial processes, pasteurization and other commercial processing have effects on the milk.

Processing effects on dairy substances. Milk is typically characterized by flavor, aroma, and texture. All of these are subject to a variety of harms ranging from, for example, very simple chemical additions from the diet of the cattle, to bacterial byproducts, chemical or mechanical adulteration, and air quality/exposure within the dairy. In large-scale processing facilities, it is common practice to collect milk from many cows and co-mingle it. To some degree, harms that can be traced to a particular cow (e.g., diet) or handling of that cow's milk represent the few areas in which aggregation of large numbers of cows' milk can improve the overall milk quality. However, it also means that in those cases where extremely high quality milk is obtained from a small herd (e.g., which typically have better diets and more sanitary living conditions), this high-quality milk is degraded by the aggregation process. As with the “one bad apple” analogy, it only takes one sick cow or one polluted batch to contaminate another quantity of milk.

Heat. At the processing temperatures described above, milk is heated considerably above temperatures found in the animals that produce it. The chemical stability of the substance is optimal at the body temperatures close to where nature evolved it. However, heat is essential to destroy pathogens, and considerable research stretching over the last 150 years has yielded temperature limits that seek to optimize pathogen destruction against product degradation.

For example, scalded milk is a product many people recognize. It has a definite flavor caused by the thermal alteration of its components. Batch pasteurizing, even though it uses the lowest temperatures, exposes the product to an extended period of heating, during which the character of the milk is altered. Most consumers can detect a flavor and texture change. Many people also claim to recognize the distinct texture and flavor of ultra-pasteurized milk which arises primarily from its exposure to extreme heat.

Mechanical. Not only can heat alter milk characteristics, but the mechanical treatment of the product can substantially alter its character. Three profound examples of this include homogenization, butter, and whipped cream.

Raw milk contains fat that tends to segregate. The process of homogenization uses mechanical means to break up and reduce the size of fat globules in the milk to impede their subsequent segregation. In the process, the milk texture is altered. Skilled tasters can perceive the difference between homogenized milk and raw milk.

If the cream is removed from the milk and subjected to mechanical agitation, it will eventually solidify into butter, a substantially different substance than the cream from which it arises. In addition, the remaining liquid (true non-cultured buttermilk) is substantially different than either the cream or the butter. Completely unskilled tasters can discriminate between the flavor and texture of all three of these substances.

If the cream agitation process used to make butter is changed from pulsation to whipping, the cream makes a transition to whipped cream, essentially a stiffer form of cream with tangible (and generally pleasant) texture. Completely unskilled tasters can discriminate between the flavor and texture of these two substances.

These examples show that there are unambiguous changes in the texture and, in some cases, the flavor of dairy due to mechanical insults to the product.

Large-scale facilities alter the characteristics of milk through their processing methods. While conventional batch pasteurizing systems impart minimal mechanical stresses to the milk, since the milk does not have to be transported outside the pasteurizing vessel during the process, they expose the product to an extended period of heating during which the character of the milk is altered nonetheless. Likewise, conventional processing systems according to the other two modes (i.e., flash pasteurizing and ultra-pasteurizing) process milk with a high throughput at a relatively high velocity (e.g., through long pathways of typically over 100 feet long at about 2.5 inch pathway diameter or more and producing a flow rate of about 100 gallons per minute (GPM) or more), and wherein pasteurization is often coupled with homogenization. This mechanical agitation significantly alters the milk, including in terms of its texture and flavor.

Existing flash pasteurizing and ultra-pasteurizing systems specifically aim to produce a turbulent flow as one of their process goals, to make sure the milk from many sources mixes thoroughly in the processing pathways. High throughput and flow rates (conventionally made possible by expensive, high-flow pumps) also provide the high throughput characteristic that has traditionally been deemed necessary to clean and disinfect the passageways of the system when detergent, disinfectant, or acid is coursed through the system before and after the milk is pasteurized. Not only would slower, gentler methods reduce the intentional admixing of milk within the pathways, they would also become economically impossible according to the existing paradigm that leverages larger facilities due to the large quantities of milk that these facilities must process. Slower, gentler methods also would not have the power traditionally deemed necessary to clean and disinfect the system.

In view of the foregoing, it would be desirable to provide improved systems and methods for pasteurizing milk including, for example, systems and methods that provide pasteurizing solutions to smaller-scale dairy farms and that do not appreciably alter the milk, including in terms of its texture and flavor.

### SUMMARY OF THE EMBODIMENTS

Systems and methods are provided for pasteurizing milk or other fluids, and for cleaning and disinfecting processing passageways prior to and after the milk processing.

In some embodiments, systems and methods for pasteurizing milk are provided that have a very low, if any, impact on the characteristics of the raw, unpasteurized milk. In other words, the pasteurized milk output by the system and method is the same as, or substantially the same as, the raw milk input to the system and method in terms of, for example, its texture, flavor, aroma, and/or nutritional value. For example, such a system and method may operate at a very low flow rate (e.g., less than about 5 GPM, less than about 3 GPM, or at about 1 GPM) while carefully controlling the pasteurization process including in terms of its temperature and duration of heat exposure of the raw milk, thus safeguarding and preserving the characteristics of the raw milk while ensuring that it is safe and substantially free (e.g., at least 99% or more free) of microorganisms and pathogens. Such a system is markedly different from existing HTST and ultra-pasteurizing systems that, for example, intentionally subject the milk to high flow rates to admix the milk and thus mechanically alter the milk as a result.

Some embodiments of the present invention are sized and configured to allow small-herd dairy farms (e.g., farms containing 4 to 6 cows) to economically produce and supply farm-fresh, pasteurized milk. Advantageously, four, six, and ten cow dairy farms have a much lighter and gentler impact on the landscape and environment and require only minimal facilities and minimal amounts of land. Likewise, systems produced according to some embodiments of the present invention are compact and require minimal facilities (e.g., electrical and water supplies).

In accordance with various embodiments of the present invention, the amount of mechanical agitation that is forced upon raw milk during pasteurization is reduced or minimized by providing a low-impact pump to flow the milk through the system. In some embodiments, the system is configured such that the same, low-impact pump can be used to drive the cleaning and disinfecting of the system, thus eliminating the need for an expensive, high-flow pump and making the system economical for use by smaller-scale dairy farms. In some embodiments, the milk produced by the disclosed systems and methods is not homogenized, separated, or standardized, as is typically the case with existing large-scale systems.

In some embodiments of the present invention, an apparatus for pasteurizing a fluid (e.g., raw milk) is provided that includes a heating system, a pump, and a control system. The heating system has an inlet for receipt of the fluid from a fluid source (e.g., raw milk storage container) and is configured to heat the fluid to a temperature that kills microorganisms and pathogens present within the fluid. The pump (e.g., a positive-displacement, peristaltic pump) is configured to cause the fluid to flow from the fluid source, into the heating system, and through an outlet of the heating system. The pump has a maximum flow rate of, for example, less than about 5 gallons per minute (GPM), less than about 3 GPM, or about 1 GPM. The control system is electrically connected to the pump and causes it to switch on and off.

The heating system according to some embodiments of the present invention includes a heat source and a regenerative heat exchanger. The heat exchanger includes a pre-heating section, a heating section, and a cooling section. In some embodiments, the pre-heating section includes the inlet that is configured for receipt of the fluid from the fluid source. The cooling section provides the outlet of the heating system. In some embodiments, the length of all the fluid pathways between the inlet of the heating system to the outlet of the heating system does not exceed 15 feet (e.g., less than or equal to 12 feet), and the diameter of those fluid pathways does not exceed 2 inches (e.g., less than or equal to 1 inch), to reduce and preferably minimize agitation of the milk during processing.

In some embodiments of the present invention, the pasteurizer also includes a diverter valve having an inlet for receipt of fluid from the heating section of the regenerative heat exchanger. The diverter valve also includes a first outlet connected to an inlet of the cooling section of the regenerative heat exchanger, and a second outlet connected to the inlet of the pre-heating section of the regenerative heat exchanger. The control system is configured to cause the diverter valve to output the fluid to a selected one of the first and second outlets depending, for example, on the status of a temperature signal received by the control system from a temperature probe.

In some embodiments of the present invention, an apparatus for cleaning or sanitizing the fluid passageways of a low-flow pasteurizer is provided. The apparatus includes a source of cleaning or sanitizing fluid, a heating system (which is normally off during the cleaning/sanitizing process), a pump, and a pressure pulsing apparatus. The heating system has an inlet configured for receipt of fluid from the fluid source, an outlet, and one or more fluid conduits connecting the inlet to the outlet. The pump is configured to cause the fluid to flow from the fluid source, into the inlet of the heating system, and through the outlet of the heating system. The pump has a maximum flow rate of, for example, less than about 5 gallons per minute (GPM), less than about 3 GPM, or about 1 GPM. The pressure pulsing apparatus (e.g., including a valve or other flow interruptor) has an inlet connected to the outlet of the heating system. In a first configuration, the pressure pulsing apparatus blocks passage of the fluid from the outlet of the heating system thus allowing pressure to build up within the one or more fluid conduits of the heating system as the pump continues to operate. In a second configuration, the pressure pulsing apparatus allows passage of the fluid out of the outlet of the heating system from the pressurized one or more fluid conduits to purge air from the fluid conduits and to cause all or substantially all (e.g., at least 99%) of the interior surfaces of the one or more fluid conduits to come into contact with the cleaning or sanitizing fluid.

Methods for low-impact pasteurizing of fluid (e.g., raw milk) and methods for cleaning or sanitizing fluid passageways used for low-flow pasteurization are also provided.

### BRIEF DESCRIPTION OF THE FIGURES

For a better understanding of the present invention, reference is made to the following description, taken in conjunction with the accompanying drawings, in which like reference characters refer to like parts throughout, and in which:

FIG. 1 is a block diagram of a system for pasteurizing milk according to some embodiments of the present invention;

FIG. 2 is a schematic diagram of a flexible hose for use in the system of FIG. 1 according to some embodiments of the present invention, for example, as the timing loop that retains the milk at a desired temperature (e.g., 163° F.) for a predetermined period of time (e.g., 20 seconds);

FIG. 3 shows left, top, and front views of the pasteurizing system of FIG. 1 according to some embodiments of the present invention;

FIG. 4 is a block diagram of the system of FIG. 1 as configured according to some embodiments of the present invention to perform a sanitizing and/or cleaning cycle before and/or after the milk is processed, wherein the system contains a pressure pulsing apparatus for facilitating sanitizing and/or washing of the system (e.g., without the need for a high throughput pump);

FIG. 5 is a block diagram of the pressure pulsing apparatus of FIG. 4 according to some embodiments of the present invention, which includes a valve that blocks the output of the pasteurizer thus allowing pressure to build up within it and then opens thus purging air from the system and permitting highly pressurized washing or sanitizing fluid to pass through the system and to contact its fluid passageways;

FIGS. 6 and 7 show another embodiment of a pressure pulsing apparatus for use in the system of FIG. 4 according to some embodiments of the present invention, which includes an air-activated compression bar that restricts or permits fluid to flow from an output of the pasteurizer;

FIG. 8 is a flowchart of illustrative stages involved in pasteurizing a fluid according to some embodiments of the present invention;

FIG. 9 is a flowchart of illustrative stages involved in low-impact pasteurization of raw milk or another fluid according to some embodiments of the present invention; and

FIG. 10 is a flowchart of illustrative stages involved in cleaning or sanitizing fluid passageways of a pasteurizer according to some embodiments of the present invention.

### DETAILED DESCRIPTION OF THE EMBODIMENTS

While the present disclosure makes references to the pasteurization/processing of cow's milk, one of ordinary skill in the art will understand that the systems, processes and devices disclosed herein are equally applicable to other types of milk products (e.g., goat's milk), water, various juices, and any other liquids susceptible to bacterial contamination (for example).

Some embodiments of the present invention remove (e.g., kill) pathogens from raw milk while leaving its other characteristics intact. In some embodiments, minimization or reduction of the thermal exposure of the raw milk and the mechanical abuse of the substance is achieved.

In some embodiments of the present disclosure, systems and methods are presented that perform or enable at least one, and more preferably, two or more (e.g., all) of the pasteurizing functions including (for example):
economically employing a pasteurization process in a low-impact, small batch mode (e.g., configured for production of less than about 5 GPM of processed milk, less than about 3 GPM, or about 1 GPM);
minimizing the time between the collection of milk and its processing;
minimizing the time between processing and consumption;
processing with the low (and in some embodiments, the lowest) practical time/temperature combination (e.g., utilizing the HTST flash pasteurizing approach);
minimizing mechanical stresses to the milk during processing; and
assuring sterilization and cleaning without auxiliary pumps (e.g., without the need for expensive, high-flow pumps).

Some embodiments of a system for processing milk according to the present disclosure include one or more (e.g., all) of the following components:
raw storage container;
processed storage container;
product pump;
heating source;
heat exchanger;
diversion and/or priming valves (e.g., air powered);
timing loop;
other reservoir(s) (e.g., pipe(s) or tubing) for holding fluid during pasteurization or other processing;
control system;
cleaning and sterilization accessories (e.g., pressurizing valve) and controls; and
other item(s) (e.g., mechanical mounting, air compressor, and the like).

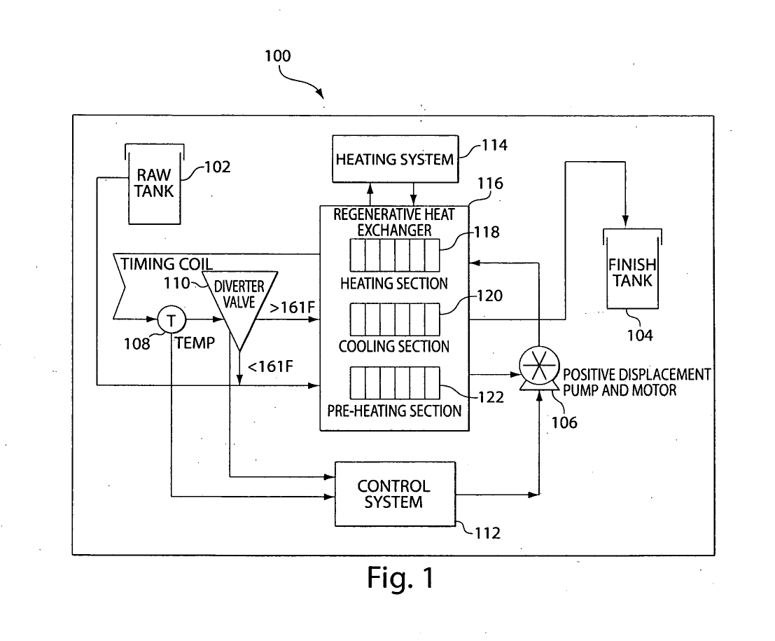

FIG. 1 is a diagram of a system 100 for pasteurizing milk according to some embodiments of the present invention. System 100 includes raw tank 102, finish tank 104, pump 106, temperature probe 108, diverter valve 110, control system 112, heating system 114, and regenerative heat exchanger 116. Regenerative heat exchanger 116 includes heating section 118, cooling section 120, and pre-heating section 122. As shown in FIG. 1, an outlet of raw tank 102, which contains unpasteurized milk (for example), is connected by a suitable fluid conduit or pathway (e.g., stainless steel pipe, flexible hose, or other tube) to an inlet of pre-heating section 122. In all instances described herein, a fluid or electrical connection between components may be direct, or indirect through one or more intervening components. For example, in the embodiment shown in FIG. 1, the outlet of raw tank 102 is connected directly to the inlet of pre-heating section 122. In other embodiments, raw tank 102 may be connected to the inlet of pre-heating section 122 indirectly through one or more intervening components (e.g., a check valve).

An outlet of pre-heating section 122 is connected to an inlet of pump 106 by a fluid pathway (e.g., stainless steel pipe, flexible hose, or other tube). An outlet of pump 106 is connected to an inlet of heating section 118, also by way of a fluid pathway. An outlet of heating section 118 is connected to an inlet of diverter valve 110 by way of another fluid pathway, wherein a temperature probe 108 is provided at, or upstream of, diverter valve 110. As used herein, the terms upstream and downstream refer to the locations of components relative to the flow of milk (or other fluid) during normal operation of system 100. For example, raw tank 102 from which the raw milk initially flows is upstream to all of the other components in system 100, including pre-heating section 122.

Diverter valve 110 has a first outlet connected to the inlet of pre-heating section 122. Diverter valve 112 also has a second outlet connected to an inlet of cooling section 120. Based at least in part on the output of temperature probe 108, which is electrically connected to an input of control system 112, control system 112 causes diverter valve 110 to divert the milk received at its inlet to a selected one of its first and second outlets. For example, when the temperature output by probe 108 is less than 161 degrees Fahrenheit (F) (or, in other embodiments, less than 163° F., for example), control system 112 may cause valve 110 to divert the milk back to pre-heating section 122 for further heating, thus assuring proper pasteurization and elimination or substantial elimination (e.g., at least 99% or more) of microorganisms and pathogens. In contrast, when the temperature output by probe 108 is greater than (e.g., or equal to) 161 degrees Fahrenheit (F) (or, in other embodiments, greater than or equal to 163° F., for example), control system 112 may cause valve 110 to divert the milk to cooling section 120. An outlet of cooling section 120 is connected to an inlet of finish tank 104.

Control system 112 may include any suitable electrical hardware (e.g., relays, timing devices), or combination of hardware and software, capable of performing the specific functions described above. Control system 112 may also include an electrical output, connected to an input of pump 106, that causes pump 106 to turn off and on. For example, in some embodiments, control system 112 may include one or more processors. In some embodiments, control system 112 may include a control panel that allows a user to control some or all aspects of the operation of system 100 such as, for example, when system 100 will initiate a pasteurization cycle, or a cleaning or sanitizing cycle, and/or what temperature reading from temperature probe 108 will cause control system 112 to change the output orientation of diverter valve 110.

In some embodiments, system 100 may be configured for an extremely low, nominal flow rate of 1 gallon per minute (GPM) (for example). At this low flow rate, mechanical abuse of the milk is substantially minimized (and in some embodiments almost eliminated, and in some embodiments, eliminated), achieving one of the primary goals of the disclosure. In some embodiments, system 100 may be configured for low-flow using, at least in part, off-the-shelf components. For example, in some embodiments, pump 106 may be a positive displacement pump manufactured by Jabsco (Model No. 12345, ITT Pureflo-21 Diaphragm Pump). Heating system 114 may be manufactured by Delta T. Systems, Inc. (Model No. SB-420). Regenerative heat exchanger 116 may be manufactured by Thermaline (Model No. T2CH-AL). Diverter valve 110 may be manufactured by Diverter Valve Stainless Products Inc. (Model No. Sp160-77-1-20). Control system 112 may include an air compressor for controlling switching of the diverter valve (and optionally a drain valve connected to an outlet of the heat exchanger), the air compressor being manufactured by Senco Products Inc. (Model No. PC1010). Additional details regarding suitable positive displacement pumps and heating systems and exchangers according to some embodiments of the present invention are described in greater detail below. Storage tank 102 and finish tank 104 may be manufactured by Nieros (e.g., Model No. BHN-0151).

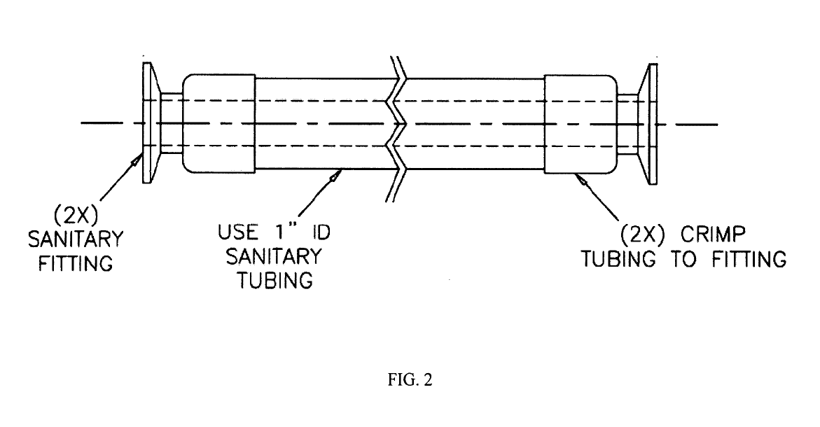

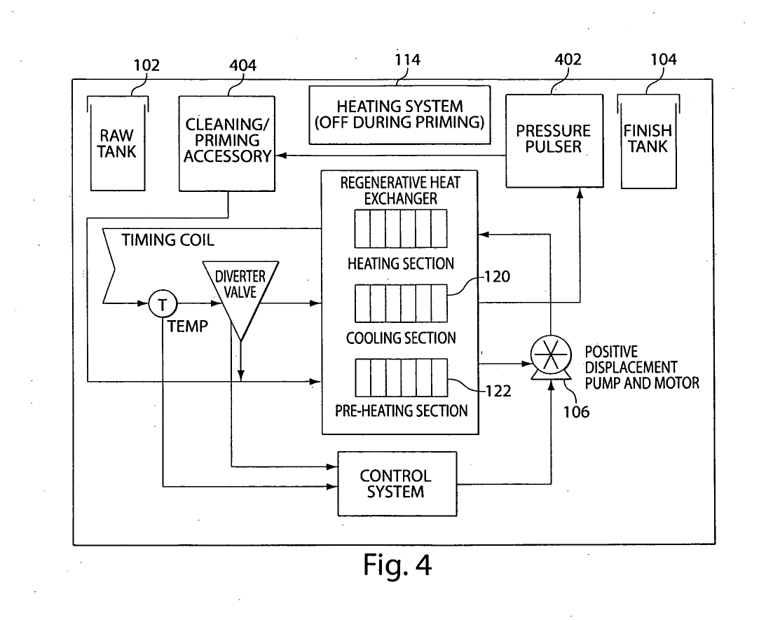

The fluid pathway connected between the outlet of heating section 118 and the inlet of diverter valve 110, which is referred to as a timing coil in FIG. 1, may include a stainless steel pipe, tank, flexible hose, tube, and/or other vessel designed to retain the milk at a desired temperature (e.g., 161° F. or 163° F.) for a certain period of time (e.g., about 15 seconds, 20 seconds, 25 seconds, etc.). The size and configuration of a suitable timing coil (e.g., a 96-inch flexible tube having 1-inch diameter) will be apparent to a person having ordinary skill in the art from the flow-rate of the system (e.g., 1 GPM, for example). For example, FIG. 2 is a schematic diagram of a flexible hose for use in the pasteurizing system of FIG. 1 according to some embodiments of the present invention. Such a flexible hose may be used, for example, as the timing loop that retains the milk at a desired temperature for a predetermined time period. In some embodiments, the hose may have sanitary fittings (e.g., one on each end) and sanitary tubing (e.g., 1-inch tubing), which may be crimped to the fittings. Advantageously, use of a flexible hose (e.g., for the timing coil) may also assist in the cleaning and sanitizing of system 100 since, under pressure (e.g., pressure produced by pump 106 in cooperation with a pressure pulsing apparatus), a flexible hose stores energy as pressure accumulation which can be released rapidly as an impulse that forces cleaning and sanitizing solution through the fluid pathways of system 100. Additional details regarding the cleaning and sanitizing of system 100 are provided below in connection with FIG. 4.

In other embodiments, system 100 may be made from proprietary parts or a combination of off-the-shelf components and proprietary parts, and/or configured for a nominal flow rate of less than or equal to about 3 GPM, less than or equal to about 5 GPM, or another flow rate (e.g., greater than 5 GPM). Adjustments to the flow rate may be achieved by adjusting the configuration and/or components of system 100. For example, a larger or more powerful pump 106 may be used, and/or the size (e.g., diameter and/or length) of one or more (e.g., all) of the fluid pathways may be increased.

Referring back to heating system 114 and regenerative heat exchanger 116, heating system 114 may contain a heat source with an independent control system (e.g., proportional—integral—derivative (PID) thermal controller) that maintains feed water to the process at a nominal set-point (e.g., about 164° F.), preferably varying by only a few degrees F. For example, heating system 114 may include one or more water input(s) (e.g., hot and/or cold water feeds), which is pumped in (e.g., at 10 GPM) by an integral pump, and a water output which is connected to a drain. The heating system employed in some embodiments of the present disclosure may utilize a three minute air purge cycle that runs high volume water through the heat input circuit and leaves it bubble free.

In some embodiments, for economic reasons, system 100 may use a heat source 114 that does not adequately provide the temperature rise demanded by the process. In such embodiments, a regenerative heat exchanger 116 may be used to initially heat incoming milk (e.g., in pre-heating section 122, utilizing already-heated milk flowing through cooling section 120 to initially heat incoming raw milk). In the process, the post-processed milk flowing through cooling section 120 is also cooled before being delivered to finish tank 104.

For example, because of the configuration of regenerative heat exchanger 116, approximately 85% of the energy is retained in the process core, which, in some embodiments, decreases the required size of the heat source significantly.

In some embodiments, a separate monitoring and recording system (either or both) (e.g., contained within control system 112) diverts the milk to bypass the cooling section 120 if the milk drops below a minimum temperature (e.g., 161° F.). Rather than divert this milk back to the input tank, the milk can be allowed to recirculate through the heat exchanger in a captive loop until it exceeds the diversion threshold temperature, at which point it may be allowed to transit section 120 of the regenerator where its heat is shed to the incoming milk stream. During this time, diverter valve 110 may prevent the milk streams coming into and exiting the heat exchanger 116 from physically contacting one another.

In some embodiments, provisions may be made in the piping configurations to assure that a pressure gradient always exists between processed milk and raw milk; in other words, a leak will always push “cleaner” milk into “dirty” milk, and thus, prevent contamination of the processed product contained in finish tank 104. For example, operation of pump 106 may contribute to or cause the creation of the pressure gradient just described.

Regarding pump 106, metering of the product flow in some embodiments may be assured using a variable frequency alternating current (AC) drive module set to a fixed frequency (for example). This drives a synchronous motor at a very precise and invariant speed. The motor may be coupled to a positive displacement pump which, by its nature, may only intake a fixed amount of fluid per revolution (in some embodiments). In this manner, pump 106 should not deliver more than 1 gallon per minute (in some embodiments), though a variety of factors can cause it to deliver less. In some embodiments, flow rates may be physically monitored (e.g., by control system 112, which may be in electrical communication with a suitable probe located downstream of pump 106). Essentially, lower flow rates will only cause the pasteurizing interval to be longer, which is within specification, since the dwell/retention times listed for the milk at elevated temperature (e.g., 15 seconds) may be minimum dwell times. In some embodiments, this system configuration may prevent higher flow rates from being realized, since the pump revolutions per minute (RPM) are limited and each revolution can only deliver a certain amount of milk.

In some embodiments, pump 106 may be arranged such that it suctions product into the pre-heating section 122 of heat exchanger 116, and emits it into high temperature section 118. This may maintain a slight though positive pressure gradient in the proper direction. Pre-heating section 122 may derive its heat from the output of the regeneration section (i.e., cooling section 120), and simultaneously cools off the outgoing product. High temperature section 118 of heat exchanger 116 may derive its heat from heating source 114.

In some embodiments, after being forced through high temperature section 118, the milk enters a timing coil (e.g., pipe, flexible hose, or other tube), which is sized to require a minimum of 15 seconds, or a minimum of 20 seconds (for example), transit time at a rate of 1 gallon per minute.

At or near the output end of the timing tube, temperature probe 108, which may be a platinum resistance temperature device (RTD), may be provided which precisely measures the output temperature. Controller 112 may use this measurement to determine the appropriate subsequent flow path, and diverter valve 110 may be either activated or deactivated to route the milk out to regeneration section 120 (where heat may be recovered) or ultimately back to the input of the heat exchanger 118 (e.g., through one or more components, such as pre-heating section 122) for recirculation (where heat may be preserved). In some embodiments, these valve(s) (e.g., diverter valve 110) may be air powered and/or solenoid controlled.

System 100 may be wired in a manner that will cause the valves to fail in the most benign manner. For example, in response to a failed thermometer in temperature probe 108, control system 112 may cause system 100 to recirculate milk. As another example, system 100 may be configured to recirculate milk when there is a missing air source (e.g., air source for the valve(s)), missing controller power, etc. Thus, at least in some embodiments, all success criteria must be met for milk to be sent to finish tank 104.

During the pasteurizing process, system controller 112 may monitor the product temperature (e.g., from temperature probe 108) and may record it (e.g., in computer storage memory contained in controller 112 or in external memory) at an interval of, for example, two (2) samples per second for recording, and several hundred samples per second of monitoring (for example). Valve activation may occur within, for example, one (1) second of threshold violation. Such storage memory may be employed to store readings on a removable memory card (for example or any memory means which may be wired or wirelessly communicated) which can provide a means for hard copy output in graphic form (e.g., printing). In some embodiments, the card may hold more than a decade's worth of continuous use, and for several decades worth at the projected system usage levels, for example. In some embodiments, audible alarms from system 100 (e.g., controlled by control system 112) may indicate proper (and/or improper) operation of system 100.

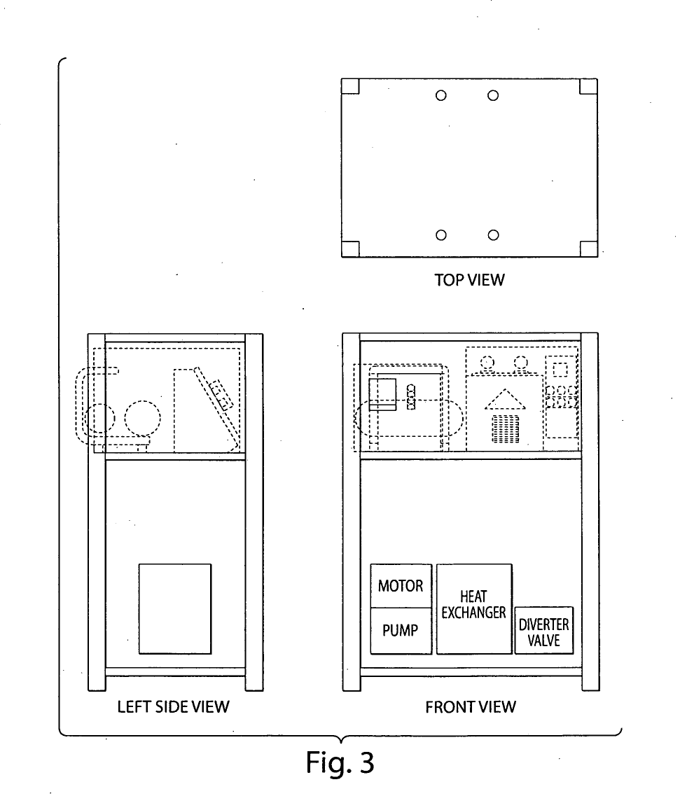

FIG. 3 shows left, top, and front views of the pasteurizing system of FIG. 1 according to some embodiments of the present invention. As shown, system 100 can be configured as a compact system, for example, 4 feet high, 3 feet wide, and 2 feet deep. Advantageously, such a pasteurizing system can be easily implemented at, for example, a small dairy farm.

FIG. 4 is a block diagram of the system of FIG. 1 as configured according to some embodiments of the present invention to perform a self-washing and/or sanitizing cycle before and/or after the milk is pasteurized. As shown, the system contains a pressure pulsing and air purging system (pressure pulser) 402 and a cleaning/priming accessory 404 for facilitating washing and/or sanitizing of the system (e.g., without the need for a high throughput pump). Pressure pulser 402 has an inlet that is connected to an outlet of system 100 such as, for example, an outlet of cooling section 120. Pressure pulser 402 is also connected to (e.g., integral with in the same assembly) cleaning/priming accessory 404. Cleaning/priming accessory 404 has an outlet that is connected to an inlet of system 100 such as, for example, an inlet of pre-heating section 122. Cleaning/priming accessory 404 may contain one or more reservoir(s) of suitable cleaning and/or sterilization agents (e.g., detergent, bleach, acid), and may be configured to meter dosages of those agents into system 100 during cleaning and/or sterilizing cycles. In some embodiments, one or more of the reservoirs (e.g., a 6 to 8 gallon tank), pressure pulser 402, and/or accessory 404, may be elevated higher than pump 106 to allow gravity to facility pumping of the cleaning and/or sanitizing agents into system 100. In some embodiments, accessory 404 may include suitable controls (e.g., hardware, or a combination of hardware and software, that start/stop the process and/or cause dosages to be metered correctly), and/or may be controlled by control system 112 described above. As shown in FIG. 4, raw tank 102 and finish tank 104 are disconnected from system 100 during the cleaning and sanitizing processes.

Pre-sterilization of internal pathways may be essential to the proper use of system 100. Accordingly, this may require that the fluid pathways (e.g., pipes, hoses, etc.) and internal surfaces be purged of air and exposed to chlorine disinfectant, for example. Under normal conditions in existing systems, for example, high flow rates are utilized to assure that all air bubbles and voids are purged properly.

Low product flow rates provided by some embodiments of the present disclosure may be insufficient, standing alone, for proper purging. Accordingly, a key and novel element in some embodiments of the present disclosure involves imitating the flow features of a high volume pump while retaining only a low-volume fixed displacement pump 106 in the system.

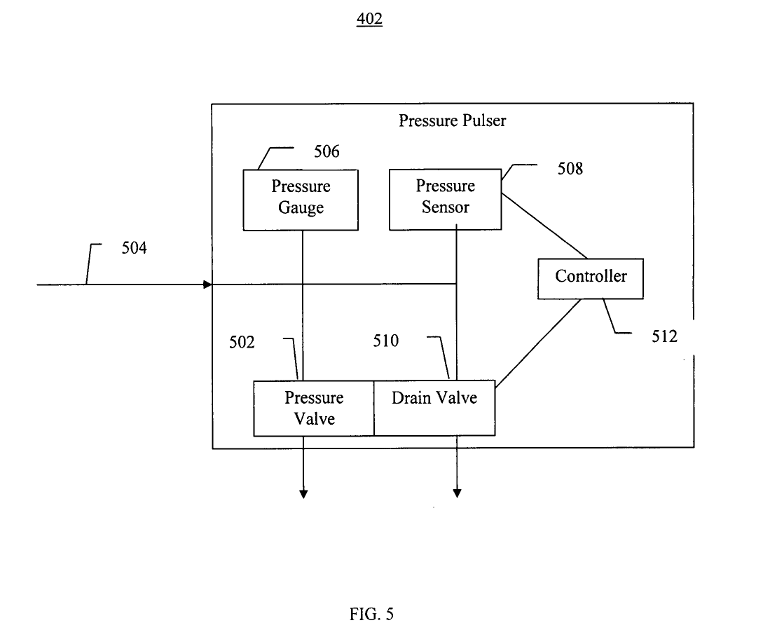

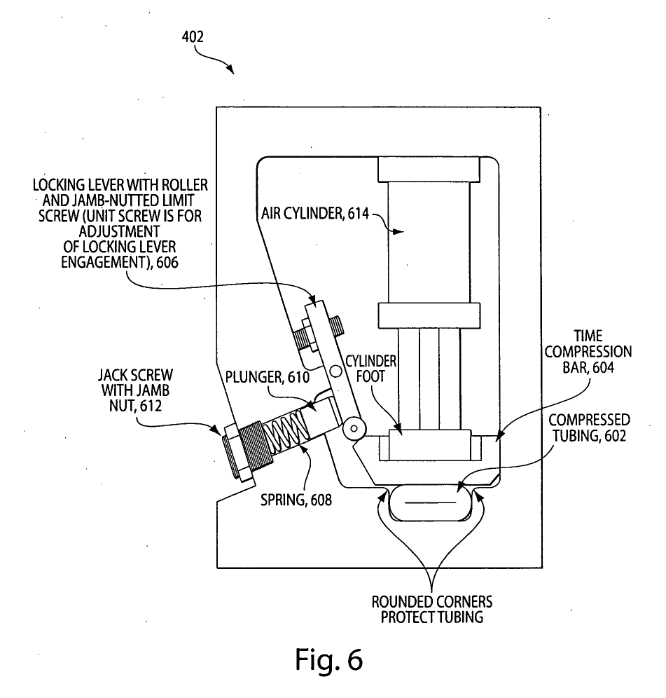

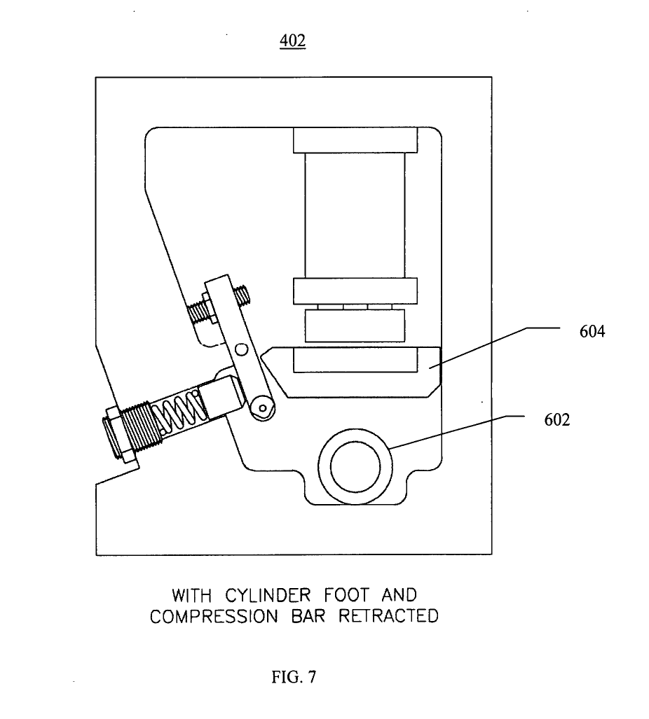

Some embodiments of the present disclosure use flow interruption during a priming cycle to flood fluid pathways (preferably all pathways). For example, in some embodiments, flow interruption may be provided by a solenoid valve located in pressure pulser 402 at an outlet port of a wash/sanitize accessory valve body (e.g., FIG. 5, described below). As another example, an air driven cylinder arrangement may be provided that compresses a flexible hose in the output path, causing a restriction (e.g., FIGS. 6 and 7, described below).

Regardless of the mechanism used to interrupt flow through system 100, during the period that flow interruption is in place pump 106 (e.g., positive displacement pump) may continue to deliver, for example, a fixed volume per minute flow of fluid to the system (e.g., 1 GPM). If there are voids (air pockets) in the flow path, they may be compressed to a much smaller size as the system pressure gradually escalates, as additional fluid is drawn in by pump 106 and less fluid (e.g., little or no fluid at all) is allowed to exit the systems. When the flow interruption is quickly removed, a spontaneous surge in flow rate may mimic the high flow rates that are normally used to purge air bubbles (for example). One or more (e.g., several) cycles of this process may be performed and, as progressive cycles decrease the trapped air, the pressure increases may occur more rapidly, until they are virtually instantaneous when the system is purged. At this point, all internal surfaces may be flooded with disinfectant and the system, according to some embodiments, is completely sterile. As described above, use of flexible hose(s) (e.g., for the timing coil) in system 100 may assist in the cleaning and sanitizing of the system since, under pressure created when flow interruption is in place, such hose(s) may store energy in the form of pressure accumulation. When the flow interruption is removed, these flexible hoses may facilitate the rapid and violent release of this pressure as an impulse that forces cleaning and sanitizing solution through the fluid pathways of system 100.

Once the cleaning/sanitizing process is complete, the input and output fluid pathways (e.g., hoses) may be connected to milk source 102, and finish tank 104, and heating source 114 may be activated (heating source 114 may be off during the cleaning/sterilizing processes). From this point forward, according to some embodiments, most (and in some embodiments, all) of the process is automatic, though some operator involvement may be needed to make sure that the comestible sterilization medium is substantially evacuated from the system before the processed milk is allowed to be captured in finish tank 104, for example. It is also possible to perform this function in an automated fashion, with for example additional controls and suitable probes, but doing so typically increases the cost of the system.

The same technique may be used during post-processing cleaning cycle to assure, for example, flooding and rinsing of internal surfaces.

Illustrative advantages of use of embodiments of the present disclosure include, for example, economic scaling of technology and purging of air from the pasteurization system using a low volume pump.

Economic scaling of technology. In some embodiments, the systems and methods disclosed herein enable milk to be processed with a minimum amount of handling, no transportation, insignificant mechanical alteration, and the lowest time/temperature combination that will assure pathogen suppression and retention of the native characteristics of raw milk. Accordingly, taken as a whole, embodiments of the present disclosure successfully address the challenges of providing continuous processing at a previously unachievable cost point.

Purging air from hydraulic conduits using a low volume pump. Some embodiments of the present disclosure provide a technique and/or accessories for flow variations in an output stream, which variations allow purging of entrapped air pockets. Use of such a feature in some embodiments of the present disclosure, as it applies to the pasteurization function, is to assure that the entire interior of the flow path is flooded with disinfectant during pre-use sterilization and with cleaning solutions in the post-use processes. Forcing the components to “save up and spend all at once” the slow, metered flow of the product pump imitates a higher flow rate system that is essential to purging without using a separate high flow pump with its attendant cost and complexity.

In some embodiments, once the system is completely disinfected in this manner, it is possible to disconnect the hoses, now fully charged with fluid, and to connect them to the feed and discharge tanks with no regard as to the introduction of air. In some embodiments, the connections points preferably are cleaned and the operator preferably practices normal hygienic connection methods common in dairy processing, but one of skill in the art will appreciate that the introduction of air becomes immaterial at this point.

FIG. 5 is a block diagram of an embodiment of the pressure pulser 402 of FIG. 4, which includes valve 502 that blocks fluid from an outlet pathway 504 of system 100 thus allowing pressure to build within system 100. Subsequently, valve 502 opens to permit highly pressurized washing or sanitizing fluid to pass through the system (via outlet pathway 504) and to purge air from system 100. The pressure pulser also includes pressure gauge 506, pressure sensor/switch 508, drain valve 510, and controller 512. Controller 512 may include any suitable hardware (e.g., one or more relays and/or timing devices), or combination of hardware and software. In other embodiments, the pressure pulser may be controlled, at least in part, by control system 112 (FIG. 1).

In some embodiments, when pump 106 draws the sanitizer or cleanser through system 100 to outlet pathway 504, the fluid is returned to a wash tank of cleaning/priming accessory 404 through valve 502 when that valve is in an open position. This allows the sanitizer or cleanser to be reused. At specific intervals during the cleaning/sanitizing cycle, valve 502 (e.g., a solenoid valve) closes thus blocking the outlet flow from outlet pathway 504 of system 100. Pump 106, which continues to run, begins to pressurize the trapped air in the system. In some embodiments, during pasteurization, and/or during the initial part of the cleaning/sanitizing cycle before pressure pulser 402 is activated, system 100 may be a low-pressure system, for example, operating between about 0 and about 10 pounds per square inch (PSI), between about 0 and about 5 PSI, between about 0 and about 2 PSI, or at less than or equal to about 1 PSI (e.g., plus or minus 10-15%), depending on the system configuration. When valve 502 closes, the pressure in the system between pump 106 and valve 502 is monitored by pressure sensor 508, which signals the controller 512 when a predetermined pressure is reached (e.g., any value between about 25 to about 100 PSI such as, for example, about 50 PSI, 55 PSI, 60 PSI, 65 PSI, or 70 PSI depending on the system configuration). At that time, valve 502 opens suddenly releasing a blast of fluid and air into a wash tank of cleaning/priming accessory 404, the momentum of which draws an impulse surge of sanitizer/cleanser through the various internal passages (e.g., pipes and/or hoses) in system 100 assuring proper washing. This cycle continues one or more (e.g., several) times (e.g., a timing circuit which is part of controller 512 may cause valve 502 to reclose, for example, 6 seconds after it opens) until any remaining trapped air is expelled from the system and the sanitizing/cleansing cycle is complete. At that time, the sanitizing/cleansing fluid is allowed to drain from the wash tank and system 100 is clean, primed with sanitizer, and ready for the inlet and outlet pathways to be attached to their proper tanks (e.g., refrigerated tanks 102 and 104) for a pasteurizing run. After the pasteurizing is complete, system 100 is rinsed and drained, the inlet and outlet pathways are re-attached to the cleaning/priming accessory 404 (e.g., and pressure pulser 402) and a similar cycle to the sanitizing cycle described above is repeated for the wash and acid rinse before the system is finally drained and stowed until further use. Drain valve 510 is normally closed, but may open to allow for additional draining once the cleaning/sanitizing cycles are complete.

FIGS. 6 and 7 show another embodiment of pressure pulser 402 of FIG. 4. As shown in FIGS. 6 and 7, this device operates by compressing a pliable outlet pathway 602 (e.g., flexible hose) of system 100 to build pressure in the system (referred to as a “locked” position), and then releases or “unlocks” pathway 602 to purge system 100 of air. The purge device illustrated in FIGS. 6 and 7 includes a tube compression bar 604 that locks under a locking lever 606 with a mechanical disadvantage. Lever 606 includes spring 608, plunger 610, and jack screw 612, which provide a required force to keep tube compression bar 604 in a locked position. Locking lever 606 is arranged to produce consistent and predictable locking behavior due to a low-friction roller. By overcoming the rubber tubing (e.g., approximately 0.1 inches in some embodiments), the lock is permitted to begin opening without releasing substantially any fluid. At the moment of release, tube compression bar 604 releases violently. Tube compression bar 604 has proper geometry for desired retention and release behavior.

Air cylinder 614 may be used to provide motive force to a cam which compresses the flexible pathway 602. This arrangement is called a pinch valve, and may be used to block flow completely. Accordingly, some embodiments of the present disclosure enhance the normal gating function by using the increasing pressure of the blocked flow to act against the blocking force and trigger an eventual release of the clamp when the pressure exceeds the holding pressure exerted by the mechanical linkage. This results in a restriction of flow and a compression of fluid and air behind the valve which results in a large surge of flow that in embodiments of the present disclosure, serves to purge entrapped air bubbles from the fluid pathways (e.g., hoses and other cavities). Because the blockage and release may be governed entirely by the physical forces presented by the air cylinder and the associated linkages, in some embodiments no electronics may be required to effect the feature that the arrangement intends.

At the same time, the intense back pressure may be prevented from exceeding the pressure limits of the earlier components, all of which may have pressure specifications and limits. Any internal leaks which are present may be of a non-critical nature, since the state of the pasteurizer when this feature is enabled is that it is empty of milk and only contains disinfectant, detergent solution, or acid solution (for example).

Further, the presence of air in the system may be reliably indicated, according to some embodiments, by the amount of time that is required for the release pressure to be attained—the longer the interval, the more air in the system. At the point where air is completely purged, the interval is very short. Comparing this interval against the initial interval can be accomplished manually or by automated means. Use of clear pathways (e.g., hoses) may allow visual verification of the absence of air in the flow path.

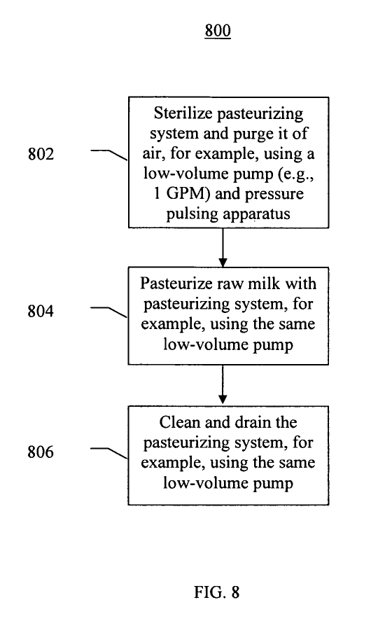

FIG. 8 is a flowchart of illustrative stages involved in a pasteurization process according to some embodiments of the present invention. For example, system 100 and/or another system embodying one or more features of the present invention may be used as shown in FIG. 8. Raw milk is collected and chilled until there is a sufficient amount available for processing. Thereafter, or concurrently, at stage 802, the pasteurizing system is sterilized and purged of air. Such sterilization and purging may be accomplished through the use of an accessory device and process (e.g., components 402 and 404 in FIG. 4). At stage 804, raw milk is then processed through the pasteurizing system and stored in the finish tank where is it chilled. For example, the pasteurization process may use the same low-volume pump used for the sterilization process. At stage 806, the pasteurizing system is then cleaned using an accessory device and process (e.g., and the same pump), and the system stowed for to await further use (i.e., a next cycle). Accordingly, the system according to such embodiments includes three processes: sterilization, pasteurization of product, and cleaning and stowing of the system.

In such embodiments, the sterilization process may include the connecting of fluid pathways/lines to the cleaning/priming accessory, charging the pathways (e.g., hoses), purging the air, and cleaning the pathways and connectors in preparation for connection to the raw and finish tanks.

In such embodiments, the pasteurization process may include connecting the pathways (e.g., hoses) to the raw and finish tanks, activating valves and allowing the system to operate in an automated, or semi-automated, fashion until the raw tank is empty.

In such embodiments, the cleaning process may include the connecting of lines to the cleaning/priming accessory, adding one or more chemicals, charging the pathways (e.g., hoses), purging the air, cleaning the pathways and connectors, and disconnecting the hoses and stowing them in preparation for future use.

The purpose of the initial, priming mode is to flood all cavities with sanitizer fluid. In this mode, the pasteurizer is not connected to either the raw or the finish tanks. Rather, the feed and exit pathways (e.g., flexible hoses) are connected to labeled connectors in the cleaning and accessory and pressure pulser, respectively. In some embodiments, water (e.g., several gallons) is added to the reservoir and disinfectant is added and dissolved/mixed therein (e.g., a few ounces). Water initially feeds via gravity into the pasteurizer. The pump may then be activated using the control switch on, for example, a control panel of control system 112. Fluid may then be suctioned into the heat exchanger pre-heat section. As this occurs, air bubbles are guided (in some embodiments via or with the assistance of gravity) into a recirculate loop where they return to a high point (e.g., highest point) in the pathway (e.g., feed hose).

After a determined time period (e.g., several minutes), a valve (e.g., diverter valve 110) is activated, which causes the majority of air to pass out of the heat exchanger and be gravity guided back (for example) to the reservoir by way of another open valve (e.g., open pressure pulser 402). The pressure pulser may then be activated, which alternately blocks and suddenly releases the pump flow, imitating very high flow rates, which act to purge the remaining air from the system.

In some embodiments, one or more viewing windows may be provided (e.g., at least partially transparent fluid pathways) through which an operator may visually verify the absence of air bubbles in the system before proceeding. Such a task may also be accomplished using sensors and the like, which are familiar to those of skill in the art.

Once air bubbles are substantially eliminated (e.g., mostly, and preferably all eliminated), the finish pathway (e.g., hose) may be disconnected (e.g., from pressure pulser 402) and connected to the entry hose of a finish tank (e.g., tank 104). The feed pathway may then be disconnected from a cleaning/priming accessory (e.g., accessory 404) and connected to a raw tank (e.g., tank 102). Prior to this, sanitary precautions and methods may be used to clean and protect the connectors to assure they are not contaminated.

During the following pasteurization interval, and according to some embodiments, the sterilizing solution is pushed out of a fully charged and sterile system by the incoming milk. At the point at which the output is determined to be free of dilution, the flow can be captured in the finish tank. The sterilization fluid may be chlorinated water, similar to public drinking water, and is generally regarded as safe (GRAS) for human consumption. Thus, minor residues of the material do not represent a health hazard.

In some embodiments, low flow rates are an intentional design goal of this system which minimizes mechanical degradation of the milk. Pasteurization specifications depend on precisely metering flow below the design limit of 1 GPM, and the design is intended to assure that this rate cannot be exceeded by the pump.

Some embodiments of the present disclosure allow such low flow rates to be achieved, and, during non-pasteurizing intervals when flow rates are not limited to 1 GPM (for example), to also achieve high flow levels for short durations, sufficient to assure purging and complete flooding.

In some embodiments, a drain valve (e.g., located as part of or upstream of finish tank 104) is left open to allow disinfectant and diluted milk to void during the first few minutes of the pasteurizing cycle. The valve is manually or automatically (e.g., by control system 112) closed once the exiting material is undiluted milk. In some embodiments, automated devices (e.g., valves) may be used and computer controlled following instructions provided by, for example, software.

The heating system is actuated (either through direct or automated control, e.g., at the outset of the pasteurization process), which is set to provide process water at a controlled 165 degrees F. (for example). In some embodiments, this system performs a 3 minute purge cycle (for example) and then begins to heat. When the heating system attains 150 degrees (for example) or more, the product pump is activated and the feed tank valve is opened. In approximately 1 minute (for example), the diverter valve will activate as the pasteurizing temperature exceeds the minimum threshold, at which point the output will be routed through the heat exchanger cooling section and exit to the finish tank.

The output draining from the tank is examined (either via an operator or automated review using sensors), and in approximately 1 minute or less (for example), the exiting milk is free from disinfectant solution and the drain valve is closed and allows the system to store pasteurized milk in the finish tank.

The system is operated until the feed tank is empty, at which point the pump is shut down and the heating system turned off.

The finish pathway (e.g., hose) may then be disconnected and placed in a floor level container to gravity drain (for example). A separate pre-cleaning process may then be performed that removes the majority of residual milk in the raw tank and the pasteurizer.

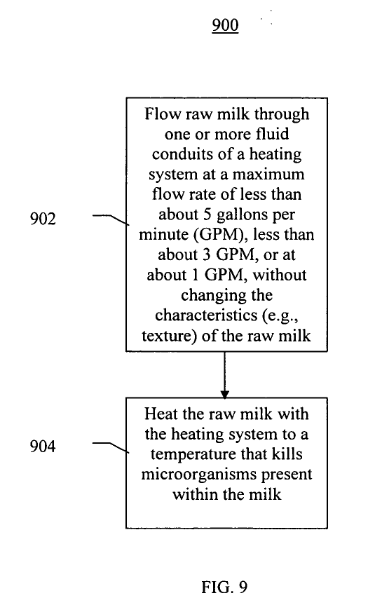

FIG. 9 is a flowchart of illustrative stages involved in low-impact pasteurizing of raw milk or other fluid according to some embodiments of the present invention. At stage 902, raw milk is flowed through one or more fluid conduits of a heating system at a maximum flow rate of less than about 5 gallons per minute (GPM), less than about 3 GPM, or of about 1 GPM, without changing the texture of the raw milk. At stage 904, the raw milk is heated with the heating system to a temperature that kills microorganisms and pathogens present within the milk. One or more (e.g., all) characteristics of the milk produced as a result of the flowing and the heating is substantially the same as that of the raw milk (e.g., texture, flavor, and/or nutritional value). In some embodiments, the flowing of the raw milk utilizes positive displacement (e.g., with a peristaltic pump), wherein a fixed amount of milk is trapped and then flowed through the one or more fluid conduits of the heating system.

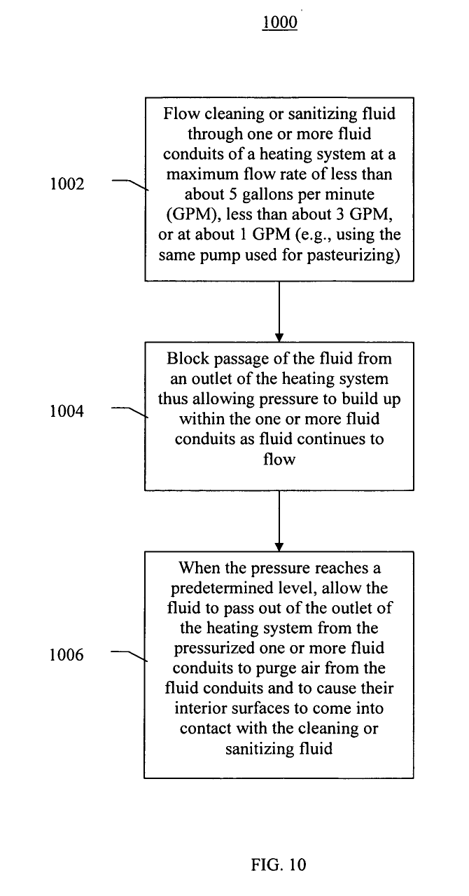

FIG. 10 is a flowchart of illustrative stages involved in cleaning or sanitizing fluid passageways used for low-flow pasteurization according to some embodiments of the present invention. At stage 1002, cleaning or sanitizing fluid is flowed through one or more fluid conduits of a heating system at a maximum flow rate of less than about 5 gallons per minute (GPM), less than about 3 GPM, or of about 1 GPM (e.g., using the same pump used for pasteurizing). At stage 1004, passage of the fluid from an outlet of the heating system is blocked thus allowing pressure to build up within the one or more fluid conduits of the heating system as the fluid continues to flow. At stage 1006, when the pressure reaches a predetermined level, the fluid is allowed to pass out of the outlet of the heating system from the pressurized one or more fluid conduits of the heating system to purge air from the fluid conduits and to cause all or substantially all (e.g., at least 99% or more) of the interior surfaces of the one or more fluid conduits to come into contact with the cleaning or sanitizing fluid. In some embodiments, the flowing of the cleaning or sanitizing fluid utilizes positive displacement (e.g., with a peristaltic pump), wherein a fixed amount of the fluid is trapped and then flowed through the one or more fluid conduits of the heating system.

Thus it is seen that systems and methods are provided for pasteurizing milk or other fluids, and for cleaning and sanitizing a pasteurizing system. Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated and may be pursued in later claims.

Insofar as embodiments of the invention described above are implementable, at least in part, using a controller or a computer system, it will be appreciated that a computer program (e.g., encoded on a computer-readable medium) for implementing at least part of the described methods and/or the described systems is envisaged as an aspect of the present invention. The computer system may be any suitable apparatus, system or device, electronic, optical, or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program, computer system, or controller(s) aforementioned may be implemented in hardware, for example by means of one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. Apparatus for pasteurizing a fluid, the apparatus comprising:
a heating system configured to heat the fluid to a temperature that kills microorganisms present within the fluid, the heating system having an inlet configured for receipt of the fluid from a fluid source and an outlet;
a pump configured to cause the fluid to flow from the fluid source, into the heating system, and through the outlet of the heating system, the pump having a maximum flow rate of less than about 5 gallons per minute (GPM); and
a control system in electrical communication with the pump, the control system configured to cause the pump to switch on and off.

2. The apparatus of claim 1, wherein the pump has a maximum flow rate of about 1 GPM.

3. The apparatus of claim 1, wherein the pump comprises a positive-displacement pump.

4. The apparatus of claim 3, wherein the positive-displacement pump comprises a peristaltic pump.

5. The apparatus of claim 1, wherein the heating system comprises:
a heat source; and
a regenerative heat exchanger comprising a pre-heating section, a heating section, and a cooling section, wherein the pre-heating section comprises the inlet configured for receipt of the fluid from the fluid source and wherein the cooling section comprises the outlet of the heating system.

6. The apparatus of claim 5, further comprising a diverter valve having an inlet for receipt of fluid from the heating section of the regenerative heat exchanger, a first outlet connected to an inlet of the cooling section, and a second outlet connected to the inlet of the pre-heating section, wherein the control system is configured to cause the diverter valve to output the fluid to a selected one of the first and second outlets.

7. The apparatus of claim 6, further comprising a temperature probe positioned between the outlet of the heating section of the regenerative heat exchanger and the inlet of the diverter valve, wherein the temperature probe is in electrical communication with the control system and wherein the control system is configured to:
cause the diverter valve to output the fluid to the first outlet which is connected to the inlet of the cooling section of the regenerative heat exchanger when the control system receives a signal from the temperature probe indicating that the fluid is heated to at least a predetermined temperature; and
cause the diverter valve to output the fluid to the second outlet which is connected to the inlet of the pre-heating section of the regenerative heat exchanger when the control system receives a signal from the temperature probe indicating that the fluid is less than a predetermined temperature.

8. The apparatus of claim 1, wherein the length of all the fluid pathways from the inlet of the heating system to the outlet of the heating system does not exceed 15 feet.

9. The apparatus of claim 8, wherein the diameter of the fluid pathways from the inlet of the heating system to the outlet of the heating system does not exceed 2 inches.

10. The apparatus of claim 1, wherein the fluid comprises milk and wherein the apparatus is configured for low-impact processing such that the processed milk exiting the apparatus has substantially the same texture as the raw milk entering the apparatus.

11. The apparatus of claim 1, further comprising a first storage tank comprising the fluid source and a second storage tank connected to the outlet of the heating system.

12. Apparatus for cleaning or sanitizing fluid passageways used for low-flow pasteurization, the apparatus comprising:
a fluid source comprising cleaning or sanitizing fluid;
a heating system comprising an inlet configured for receipt of the fluid from the fluid source, an outlet, and one or more fluid conduits connecting the inlet of the heating system to the outlet of the heating system;
a pump configured to cause the fluid to flow from the fluid source, into the inlet of the heating system, and through the outlet of the heating system, the pump having a maximum flow rate of less than about 5 gallons per minute (GPM); and
a pressure pulsing apparatus comprising an inlet connected to the outlet of the heating system, the pressure pulsing apparatus having a first configuration that blocks passage of the fluid from the outlet of the heating system thus allowing pressure to build up within the one or more fluid conduits of the heating system as the pump continues to operate, and a second configuration that allows passage of the fluid out of the outlet of the heating system from the pressurized one or more fluid conduits to purge air from the fluid conduits and to cause the interior surfaces of the one or more fluid conduits to come into contact with the cleaning or sanitizing fluid.

13. The apparatus of claim 12, wherein the pressure pulsing apparatus comprises:
a valve configured to operate in a first, closed position corresponding to the first configuration in which the passage of fluid is blocked thus pressurizing the fluid as the pump continues to operate, and in a second, open position corresponding to the second configuration in which the pressurized fluid is permitted to pass;
a pressure probe positioned in between the outlet of the heating system and the valve; and
a control system in communication with the pressure probe and the valve, wherein the control system is configured to cause the valve to open when a signal from the pressure probe indicates that the fluid has reached a predetermined pressure.

14. The apparatus of claim 12, wherein at least one of the fluid conduits of the heating system comprises a flexible hose.

15. The apparatus of claim 12, wherein the pump comprises a peristaltic pump.

16. The apparatus of claim 12, wherein the heating system is configured to remain off during cleaning or sanitizing.

17. Apparatus for pasteurizing raw milk, the apparatus comprising:
means for flowing raw milk through one or more fluid conduits of a heating system at a maximum flow rate of less than about 5 gallons per minute (GPM) without changing the texture of the raw milk; and
means for heating the raw milk with the heating system to a temperature that kills microorganisms present within raw milk,
wherein the texture of the milk produced as a result of the flowing and the heating is substantially the same as the texture of the raw milk.

18. Apparatus for cleaning or sanitizing fluid passageways used for low-flow pasteurization, the apparatus comprising:
means for flowing cleaning or sanitizing fluid through one or more fluid conduits of a heating system at a maximum flow rate of less than about 5 gallons per minute (GPM); and
means for blocking passage of the fluid from an outlet of the heating system thus allowing pressure to build up within the one or more fluid conduits of the heating system as the fluid continues to flow; and
when the pressure reaches a predetermined level, the means for blocking passage of the fluid comprises means for allowing passage of the fluid out of the outlet of the heating system from the pressurized one or more fluid conduits of the heating system to purge air from the fluid conduits and to cause the interior surfaces of the one or more fluid conduits to come into contact with the cleaning or sanitizing fluid.

19. A method for pasteurizing raw milk, the method comprising:
flowing raw milk through one or more fluid conduits of a heating system at a maximum flow rate of less than about 5 gallons per minute (GPM) without changing the texture of the raw milk; and
heating the raw milk with the heating system to a temperature that kills microorganisms present within raw milk,
wherein the texture of the milk produced as a result of the flowing and the heating is substantially the same as the texture of the raw milk.

20. The method of claim 19, wherein flowing raw milk comprises flowing the raw milk at a maximum flow rate of about 1 GPM.

21. The method of claim 19, wherein flowing raw milk comprises flowing the raw milk by positive displacement, wherein a fixed amount of milk is trapped and then flowed through the one or more fluid conduits of the heating system.

22. The method of claim 19, wherein the nutritional value of the milk produced as a result of the flowing and the heating is substantially the same as the nutritional value of the raw milk.

23. A method for cleaning or sanitizing fluid passageways used for low-flow pasteurization, the method comprising:
flowing cleaning or sanitizing fluid through one or more fluid conduits of a heating system at a maximum flow rate of less than about 5 gallons per minute (GPM); and
blocking passage of the fluid from an outlet of the heating system thus allowing pressure to build up within the one or more fluid conduits of the heating system as the fluid continues to flow; and
when the pressure reaches a predetermined level, allowing passage of the fluid out of the outlet of the heating system from the pressurized one or more fluid conduits of the heating system to purge air from the fluid conduits and to cause all or substantially all of the interior surfaces of the one or more fluid conduits to come into contact with the cleaning or sanitizing fluid.

24. The method of claim 23, wherein flowing the cleaning or sanitizing fluid comprises flowing the fluid at a maximum flow rate of about 1 GPM.

25. The method of claim 23, wherein flowing the cleaning or sanitizing fluid comprises flowing the fluid by positive displacement, wherein a fixed amount of the fluid is trapped and then flowed through the one or more fluid conduits of the heating system.
